(19) United States
(12) Patent Application Publication
(10) Pub. No.: US 2026/0228767 A1
(43) Pub. Date: Aug. 6, 2026

(54) SYSTEMS AND METHODS FOR PREDICTIVE VALUATION OF NON-FUNGIBLE TOKENS

(71) Applicant: Wells Fargo Bank, N.A., San Francisco, CA (US)

(72) Inventors: Ananth Kendapadi, Charlotte, NC (US); Ramesh babu Sarvesetty, Bangalore (IN); Himanshu Baral, Fremont, CA (US); John Penacerrada, Brentwood, CA (US); Manpreet Singh, Telangana (IN); Vinothkumar Venkataraman, Bangalore (IN)

(21) Appl. No.: 18/058,044

(22) Filed: Nov. 22, 2022

(51) Int. Cl. G06Q 30/0201; G06Q 30/0202

(52) U.S. Cl. CPC G06Q 30/0206; G06Q 30/0278

(57) ABSTRACT

Systems, apparatuses, methods, and computer program products are disclosed for generating a predictive valuation for a non-fungible token (NFT). An example method includes generating, by a NFT valuation engine and using a valuation machine learning framework, a plurality of contribution features of the NFT, where each contribution feature corresponds to an attribute of the NFT and each contribution feature is associated with a feature type. The example method further includes determining a plurality of per-feature prediction contribution scores, wherein each per-feature prediction contribution score corresponds to a contribution feature. The example method further includes determining a predictive valuation score for the NFT based on each per-feature prediction contribution score. The example method further includes providing, by a communications hardware, a predictive valuation report for the NFT based on at least one of the plurality of per-feature prediction contribution scores or the predictive valuation score.

### BACKGROUND

Blockchain technology may refer to the use of a distributed ledger that can process transactions across a network without a single point of failure. This technology has grown rapidly in recent years in terms of popularity and technological advancement. Blockchain technologies have seen an explosion in popularity particularly in the form of cryptocurrencies, and more recently, non-fungible tokens (NFT), a type of blockchain token.

### BRIEF SUMMARY

As discussed above, blockchain technologies have exploded in popularity. However, the full extent of applications of blockchain technology is still being explored. Proponents of blockchain posit that it could revolutionize the banking and financial services industry by cutting costs, increasing the speed and reliability of transactions, and improving the security of financial data. For example, it has been proposed that NFTs could be used to process transactions involving properties such as real estate or certain securities.

The market for NFTs today is dominated by NFTs that are associated with non-physical assets. Collectors buy, sell, mint, and trade NFTs for their value as collectible items. These NFTs are not necessarily connected with a physical or financial asset, but rather are connected to digital assets or, in some cases, intellectual property rights related to these digital assets. A challenge for collectors and financial institutions is to accurately assess the value of these purely non-physical NFTs. Collectors must rely on subjective perceptions of the worth of an NFT, and financial institutions may be reluctant to involve themselves in the trading of NFTs due to the difficulty in consistently assessing their value.

To address the difficulties that arise in valuation of NFTs, example embodiments described herein generate a predictive valuation of NFTs using a valuation machine learning framework. Example embodiments may algorithmically predict a value for an NFT, increasing the confidence of collectors and financial institutions that may be involved in an NFT trade. Example embodiments may draw data from a variety of sources related to the NFT, and may report not only a summary predictive valuation, but a detailed report of the NFT valuation which assesses contributions and impacts of certain attributes of the NFT, such as the NFT creator, collection, previous owners, or the like.

Accordingly, the present disclosure sets forth systems, methods, and apparatuses that leverage machine learning technology and blockchain technology to generate a predictive valuation of an NFT. There are many advantages of these and other embodiments described herein. For example, NFT creators may use example embodiments to predict how certain NFT attributes may impact the value of an NFT they plan to mint. For financial institutions, having the ability to perform valuation of NFTs provides greater confidence, for example, in an instance where an NFT may be used as collateral for a loan. For financial institutions, gaining competency and experience in the world of digital asset NFT trading also provides a chance to build the infrastructure for future use of blockchain technology for physical or financial assets linked to NFTs. Example embodiments that generate predictive valuation of NFTs thus facilitate entry into the NFT trading market for individuals and institutions.

In one example embodiment, a method is provided for generating a predictive valuation for a non-fungible token. The method includes generating, by a non-fungible token valuation engine and using a valuation machine learning framework, a plurality of contribution features of the non-fungible token, wherein each contribution feature corresponds to an attribute of the non-fungible token and each contribution feature is associated with a feature type. The method further includes determining, by the non-fungible token valuation engine and using the valuation machine learning framework, a plurality of per-feature prediction contribution scores, wherein each per-feature prediction contribution score corresponds to a particular contribution feature. The method further includes determining, by the non-fungible token valuation engine and using the valuation machine learning framework, a predictive valuation score for the non-fungible token based on each per-feature prediction contribution score. The method further includes providing, by a communications hardware, a predictive valuation report for the non-fungible token based on at least one of the plurality of per-feature prediction contribution scores or the predictive valuation score.

In another example embodiment, an apparatus is provided for generating a predictive valuation for a non-fungible token. The apparatus includes non-fungible token valuation engine configured to generate, using a valuation machine learning framework, a plurality of contribution features of the non-fungible token, wherein each contribution feature corresponds to an attribute of the non-fungible token and each contribution feature is associated with a feature type. The non-fungible token valuation engine is further configured to determine, using the valuation machine learning framework, a plurality of per-feature prediction contribution scores, wherein each per-feature prediction contribution score corresponds to a particular contribution feature. The non-fungible token valuation engine is further configured to determine, using the valuation machine learning framework, a predictive valuation score for the non-fungible token based on each per-feature prediction contribution score. The apparatus further includes communications hardware configured to provide a predictive valuation report for the non-fungible token based on at least one of the plurality of per-feature prediction contribution scores or the predictive valuation score.

In another example embodiment, a computer program product is provided for generating a predictive valuation for a non-fungible token. The computer program product includes at least one non-transitory computer-readable storage medium storing software instructions that, when executed, cause an apparatus to generate, using a valuation machine learning framework, a plurality of contribution features of the non-fungible token, wherein each contribution feature corresponds to an attribute of the non-fungible token and each contribution feature is associated with a feature type. The at least one non-transitory computer-readable storage medium storing the software instructions that, when executed, further cause an apparatus to determine, using the valuation machine learning framework, a plurality of per-feature prediction contribution scores, wherein each per-feature prediction contribution score corresponds to a particular contribution feature. The at least one non-transitory computer-readable storage medium storing the software instructions that, when executed, further cause an apparatus to determine, using the valuation machine learning framework, a predictive valuation score for the non-fungible token based on each per-feature prediction contribution score. The at least one non-transitory computer-readable storage medium storing the software instructions that, when executed, further cause an apparatus to provide a predictive valuation report for the non-fungible token based on at least one of the plurality of per-feature prediction contribution scores or the predictive valuation score.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for generating a predictive valuation for an NFT, in accordance with some example embodiments described herein.

FIG. 2 illustrates a schematic block diagram of example circuitry embodying a device that may perform various operations in accordance with some example embodiments described herein.

FIG. 3 illustrates a schematic block diagram of an example valuation machine learning framework.

FIG. 4 illustrates an example flowchart for generating a predictive valuation for an NFT, in accordance with some example embodiments described herein.

FIG. 5 illustrates an example flowchart for generating a plurality of contribution features of the NFT, in accordance with some example embodiments described herein.

FIG. 6 illustrates an example flowchart for determining a predictive valuation score for the NFT, in accordance with some example embodiments described herein.

FIG. 7 depicts an operational example of an entity contribution score report in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “block” refers to a data structure associated with a blockchain. For example, a block may comprise a model definition data structure, a block header data structure, a technical data structure, a business data structure, an operational data structure, a next block information data structure, any other suitable electronic information or data structure associated therewith (including, but not limited to, links or pointers), or any combination thereof. A block header data structure may comprise a current block hash value data structure, a previous block hash value data structure, a next block hash value data structure, a Merkle root hash value data structure, a nonce value data structure, any other suitable electronic information or data structure associated therewith (including, but not limited to, links or pointers), or any combination thereof.

The term “blockchain” may refer to a digital ledger which includes an expandable list of blocks. For example, a blockchain may include a plurality of blocks, any other suitable electronic information or data structure associated therewith (including, but not limited to, links or pointers), or any combination thereof.

The term “node device” or “node” may refer to a computing device, such as a server device, client device, a database server device, a data storage device, or a blockchain data storage device that stores one or more portions of a blockchain. For example, a node device may comprise a server device, a client device, a database, a database server device, any other suitable device or data structure associated therewith (including, but not limited to, links or pointers), or any combination thereof.

The term “smart contract” may refer to any code usable to perform changes in a blockchain or to carry some process in the blockchain. For example, a smart contract may comprise one or more blockchain-based data structures that digitally facilitate, verify, or enforce the negotiation or performance of a contract between parties.

The term “NFT” or “blockchain token” may refer to a record on a blockchain that may be transferred or traded, and typically comprises unique metadata. NFTs may be associated with a particular asset, either digital or physical. An NFT may comprise a metadata structure, containing information such as the date and time of the token's creation, a name and description of the blockchain token, and links or other data relating the NFT to an asset. Possession of the blockchain token or NFT may confer ownership rights over the asset linked to the NFT. NFTs associated with a digital asset may be linked to a particular image data, and may comprise a uniform resource identifier or uniform resource locator that provides the location of the linked image data.

The term “collection” may refer to a set of NFTs created by the same entity. The entity creating the NFT collection may any organization or individual, such as a particular artist or group of artists. NFTs of the same collection frequently have common characteristics, for example in the event where image data is associated with the NFTs of an example collection, the NFTs of the example collection may have visual similarities in their image data. Individual NFTs of the example collection may have various attributes that differentiate the image data of each NFT in the example collection of NFTs.

The term “contribution feature” may refer to a data construct that is a feature associated with an NFT that may have an effect on the price of the NFT. For example, in an instance where an example NFT is associated with image data, a contribution feature may be related to the image data, such as certain artistic styles, image attributes, colors, or the like. Additionally, a contribution feature may be related to other metadata of the example NFT such as an identity of a previous owner, an identity of a user that created the NFT, an identity of an artist that created the image data associated with the NFT, and/or the like. A contribution feature may have variable dimensionality. Each contribution feature may be associated with a feature type. The feature type may be indicative of the particular dimensionality of the contribution feature. For example, the feature type may be indicative of whether the contribution feature is single dimensional or multi-dimensional. The feature type may also be indicative of what attributes are associated with the given contribution feature. For example, if the NFT depicts a hat in the image, the hat may be a contribution feature and correspond to an “object’ feature type. Each object feature type may be associated with a color attribute, a style attribute, and/or the like. As such a blue cowboy hat contribution feature may correspond to a “blue” color attribute and “cowboy” style attribute.

The term “predictive valuation report” may refer to a data construct which describes the predictive valuation for an NFT. The predictive valuation report may describe an expected value for the sale or purchase price of the NFT. The predictive valuation report may further include a confidence interval, a classification of the NFT valuation into one or more categories, and/or detailed valuation information related to the contribution features of the NFT.

The term “valuation machine learning framework” may describe a system architecture which may be used to process an NFT and generate at least a predictive valuation score for the NFT. The valuation machine learning framework may include an extraction machine learning model, one or more contribution feature determination machine learning models, one or more per-feature prediction machine learning models, and/or a predictive valuation machine learning model. The valuation machine learning framework may use the one or more included models to process the NFT, generate a plurality of per-feature prediction contribution sores, and a predictive valuation score for the NFT.

The term “extraction machine learning model” may refer to a data construct that is configured to describe parameter, hyper-parameters, and/or stored operations of a machine learning model to process an NFT input to generate one or more base contribution features. In some embodiments, the extraction machine learning model may be a trained convolutional neural network (CNN) and/or may use one or more natural language processing (NLP) techniques to process the NFT. In some embodiments, the base contribution feature may be a data construct which describes corresponding feature attribute (e.g., unprocessed) of an NFT and may also describe the feature type. In some embodiments, the base contribution feature may be indicative of a feature attribute location (e.g., the pixels corresponding to a feature attribute) within the NFT image, a text sequence, and/or the like.

The term “contribution feature determination machine learning model” may refer to a data construct that is configured to describe parameters, hyper-parameters, and/or stored operations of a machine learning model to process one or more base contribution features to generate a contribution feature. In some embodiments, the contribution feature determination machine learning model is a machine learning model which is trained to process base contribution features of a particular feature type. In some embodiments, the contribution feature determination machine learning model may be a trained CNN and/or may use one or more NLP techniques to process the one or more base contribution features. The contribution feature determination machine learning model may determine one or more attributes for a base contribution feature (e.g., a color attribute, style attribute, etc.). The number of attributes determined for a base contribution feature may be dependent upon the feature type associated with the base contribution feature. Attributes may be a primitive data type such as a string, integer, floating point number, or the like. The contribution feature determination machine learning model may the determine the contribution feature based on the base contribution feature and the one or more attributes for the base contribution feature.

The term “per-feature prediction machine learning model” may refer to a data construct that is configured to describe parameter, hyper-parameters, and/or stored operations of a machine learning model to process one or more contribution features to generate a per-feature prediction contribution score. In some embodiments, the contribution feature determination machine learning model is a machine learning model which is trained to process contribution features of a particular feature type. In some embodiments, the per-feature prediction machine learning model may be trained using an NFT training data set which includes previous NFT transactions and corresponding NFT contribution features.

The per-feature prediction machine learning model may be configured to generate a per-feature prediction contribution score for the contribution feature based on the one or more attributes of the contribution feature. Each per-feature prediction contribution may be indicative of an estimated value of the contribution feature.

The term “predictive valuation machine learning model” may refer to a data construct that is configured to describe parameters, hyper-parameters, and/or stored operations of a machine learning model to process one or more per-feature prediction contribution scores to generate a predictive valuation score. In some embodiments, the predictive valuation machine learning model is a machine learning model is configured to process per-feature prediction contribution scores from each per-feature prediction machine learning model. In some embodiments, the predictive valuation machine learning model may be trained using an NFT training data set which includes previous NFT transactions and corresponding NFT contribution features. The predictive valuation machine learning model may be configured to generate the predictive valuation score based on the one or more per-feature prediction contribution scores. In some embodiments, each per-feature prediction contribution may be weighted using a parameter obtained during predictive valuation machine learning model training. In some embodiments, the predictive valuation score is determined based on one or more pairwise feature interaction scores obtained for each pair of contribution features.

### System Architecture

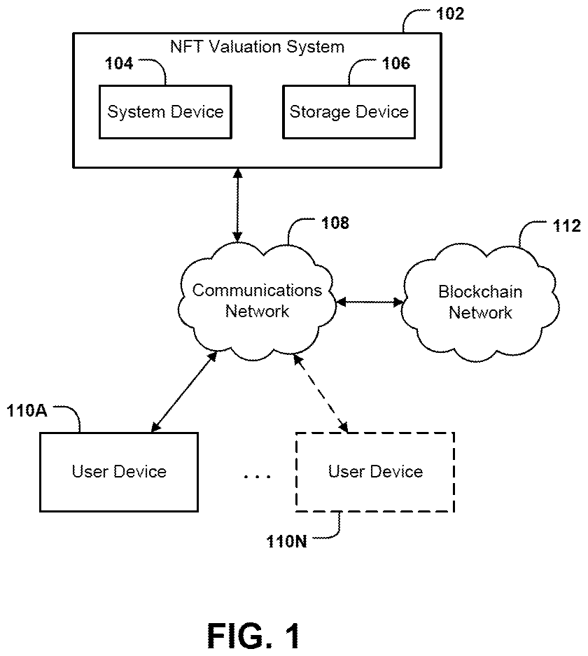

Example embodiments described herein may be implemented using any of a variety of computing devices or servers. To this end, FIG. 1 illustrates an example environment within which various embodiments may operate. As illustrated, an NFT valuation system 102 may include a system device 104 in communication with a storage device 106. Although system device 104 and storage device 106 are described in singular form, some embodiments may utilize more than one system device 104 and/or more than one storage device 106. Additionally, some embodiments of the NFT valuation system 102 may not require a storage device 106 at all. Whatever the implementation, the NFT valuation system 102, and its constituent system device 104 and/or storage device 106 may receive and/or transmit information via communications network 108 (e.g., the Internet) with any number of other devices, such as one or more of user device 110A through user device 110N. The communications network 108 may communicate with a blockchain network 112, which may comprise various blockchain nodes that maintain a distributed ledger.

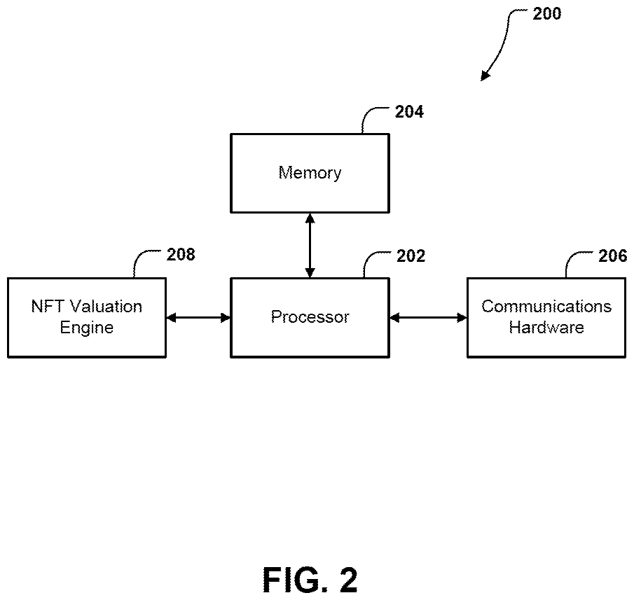

The system device 104 may be implemented as one or more servers, which may or may not be physically proximate to other components of the NFT valuation system 102. Furthermore, some components of system device 104 may be physically proximate to the other components of the NFT valuation system 102 while other components are not. The system device 104 may receive, process, generate, and transmit data, signals, and electronic information to facilitate the operations of the NFT valuation system 102. Particular components of system device 104 are described in greater detail below with reference to apparatus 200 in connection with FIG. 2.

The storage device 106 may comprise a distinct component from system device 104, or may comprise an element of system device 104 (e.g., memory 204, as described below in connection with FIG. 2). The storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). The storage device 106 may host the software executed to operate the NFT valuation system 102. The storage device 106 may store information relied upon during operation of the NFT valuation system 102, such as various blockchain transaction records that may be used by the NFT valuation system 102, data and documents to be analyzed using the NFT valuation system 102, or the like. In addition, the storage device 106 may store control signals, device characteristics, and access credentials enabling interaction between the NFT valuation system 102 and one or more of the user device 110A-110N.

The one or more user device 110A-110N may be embodied by any computing devices known in the art, such as desktop or laptop computers, tablet devices, smartphones, or the like. The one or more user device 110A-110N need not themselves be independent devices, but may be peripheral devices communicatively coupled to other computing devices.

The blockchain network 112 is a collection of networked node devices of a blockchain, which may be permissionless (public), or permissioned (private). The blockchain network 112 may use any distributed ledger or blockchain technology that is capable of creating and exchanging NFTs. In some embodiments, the blockchain network 112 may allow for Turing-complete scripting of contracts, known also as smart contracts, to be executed on the blockchain. The blockchain network 112 may be related to other blockchain networks not pictured here. For example, the blockchain network 112 may be a sidechain of another blockchain network, or another network (not shown) may form a sidechain of the blockchain network 112. The nodes may be embodied by specialized node devices, or may be embodied by any computing devices or server devices known in the art. In some embodiments the NFT valuation system 102 itself may be a node of the blockchain network 112, or the NFT valuation system 102 may be external to the blockchain.

Although FIG. 1 illustrates an environment and implementation in which the NFT valuation system 102 interacts with one or more of user device 110A-110N in some embodiments users may directly interact with the NFT valuation system 102 (e.g., via communications hardware 206 of system device 104), in which case a separate user device 110A may not be utilized. Whether by way of direct interaction or via a separate user device 110A, a user may communicate with, operate, control, modify, or otherwise interact with the NFT valuation system 102 to perform the various functions and achieve the various benefits described herein.

### Example Implementing Apparatuses

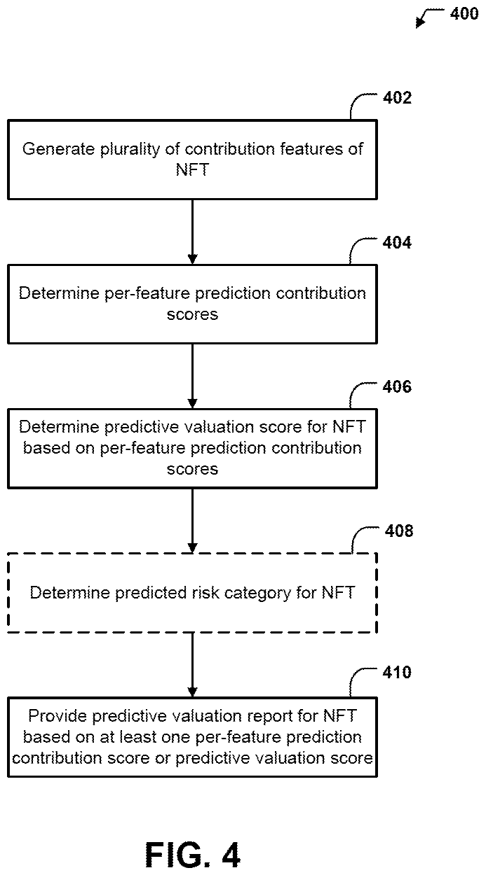

The system device 104 of the NFT valuation system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, and NFT valuation engine 208, each of which will be described in greater detail below. While the various components are only illustrated in FIG. 2 as being connected with processor 202, it will be understood that the apparatus 200 may further comprise a bus (not expressly shown in FIG. 2) for passing information amongst any combination of the various components of the apparatus 200. The apparatus 200 may be configured to execute various operations described above in connection with FIG. 1 and below in connection with FIGS. 4-6.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may be further configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

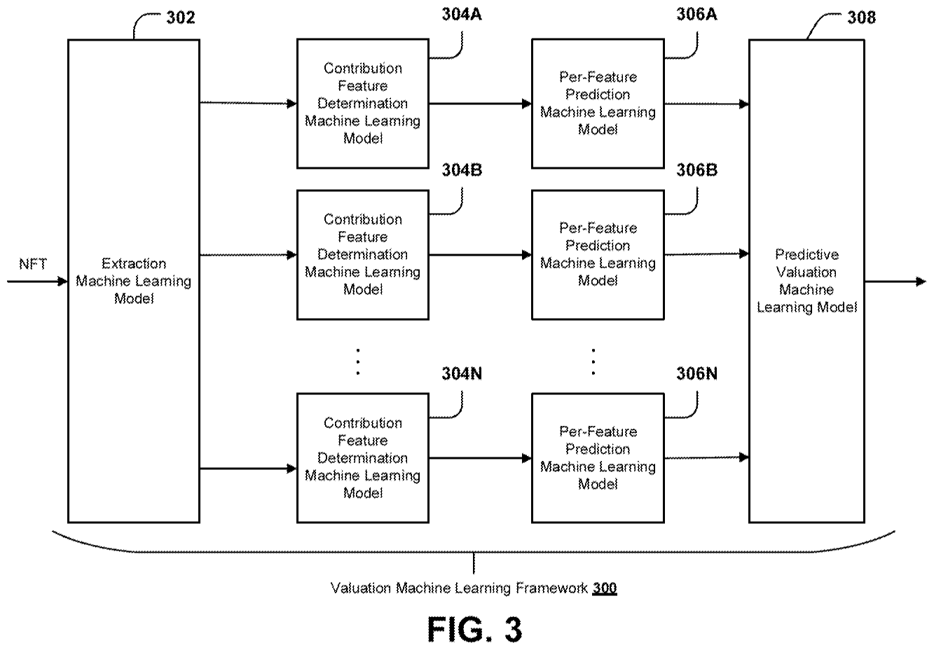

In addition, the apparatus 200 further comprises a NFT valuation engine 208 that predicts the value of an NFT. In some embodiments, the NFT valuation engine 208 may generate a plurality of contribution features of the NFT, determine a plurality of per-feature prediction contribution scores, and/or determine a predictive valuation score for the NFT. The NFT valuation engine 208 may utilize processor 202, memory 204, or any other hardware component included in the apparatus 200 to perform these operations, as described in connection with FIGS. 4-6 below. The NFT valuation engine 208 may further utilize communications hardware 206 to gather data from a variety of sources (e.g., user device 110A through user device 110N or storage device 106, as shown in FIG. 1) or to receive data from a user, and in some embodiments may utilize processor 202 and/or memory 204 to predict NFT values. The NFT valuation engine 208 may leverage various models of the valuation machine learning framework 300 to predict the value of an NFT. The valuation machine learning framework 300 is described in further detail below in connection with FIG. 3.

Although components of FIG. 2 are described in part using functional language, it will be understood that the particular implementations necessarily include the use of particular hardware. It should also be understood that certain of these components of FIG. 2 may include similar or common hardware. For example, the NFT valuation engine 208 may at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the NFT valuation engine 208 may leverage processor 202, memory 204, or communications hardware 206, as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), memory 204, or communications hardware 206 for enabling any functions not performed by special-purpose hardware elements. In all embodiments, however, it will be understood that the NFT valuation engine 208 is implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components described above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

### Valuation Machine Learning Framework

Turning to FIG. 3, an example diagram is illustrated that contains a block representation of the valuation machine learning framework 300 for generating a predictive valuation of an NFT. The valuation machine learning framework 300 may receive an NFT of interest as input (e.g., from one or more external computing devices). The NFT may be input into the extraction machine learning model 302. The extraction machine learning model 302 may process the NFT input to generate and output a plurality of base contribution features.

Each base contribution feature may be input into a contribution feature determination machine learning model of the one or more contribution feature determination machine learning models 304A-304N. Each contribution feature determination machine learning model may be trained to process a base feature corresponding to a particular feature type such that base features associated with a particular feature type are processed by a contribution feature determination machine learning model trained for the corresponding feature type. Each contribution feature determination machine learning model may generate one or more contribution features, which each correspond to a base contribution feature.

The one or more contribution features output by each contribution feature determination machine learning model 304A-304N may be input into a respective per-feature prediction machine learning model of a plurality of per-feature prediction machine learning models 306A-306N. Each per-feature prediction machine learning model may be trained to process a contribution feature corresponding to a particular feature type such that contribution features associated with a particular feature type are processed by a per-feature prediction machine learning model trained for the corresponding feature type. Each per-feature prediction machine learning model may generate one or more per-feature prediction contribution scores, which each correspond to a contribution feature.

The predictive valuation machine learning model 308 may receive and process each per-feature contribution score and generate a predictive valuation score of the NFT. The predictive valuation machine learning model may output the predictive valuation score for further processing and/or output.

### Example Operations

Turning to FIGS. 4-6, example flowcharts are illustrated that contain example operations implemented by example embodiments described herein. The operations illustrated in FIGS. 4-6 may, for example, be performed by system device 104 of the NFT valuation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, NFT valuation engine 208, and/or any combination thereof. It will be understood that user interaction with the NFT valuation system 102 may occur directly via communications hardware 206, or may instead be facilitated by a separate user device (e.g. user device 110A-110N), as shown in FIG. 1, and which may have similar or equivalent physical componentry facilitating such user interaction.

Turning first to FIG. 4, example operations 400 are shown for generating a predictive valuation of an NFT. As shown by operation 402, the apparatus 200 includes means, such as processor 202, memory 204, communications hardware 206, NFT valuation engine 208, or the like, for generating a plurality of contribution features of the NFT. Each contribution feature corresponds to an attribute of the NFT and each contribution feature is associated with a feature type. A contribution feature may be a feature associated with an NFT that may have an effect on the price of the NFT. For example, in an instance where an example NFT is associated with image data, a contribution feature may be related to the image data, such as certain artistic styles, image attributes, colors, or the like. Additionally, a contribution feature may be related to other metadata of the example NFT such as an identity of a previous owner, an identity of a user that created the NFT, an identity of an artist that created the image data associated with the NFT, and/or the like.

A contribution feature may have variable dimensionality and may be associated with a feature type. The feature type may be indicative of the particular dimensionality of the contribution feature. The feature type may also be indicative of whether the contribution feature is single dimensioned or multi-dimensioned. The feature type may also be indicative of what attributes are associated with the given contribution feature. For example, an “NFT author” contribution feature type may refer to the author of the NFT and may be single dimensioned as it is associated with a single attribute description (e.g., the NFT author username). As another example, an “NFT object” contribution feature type may refer to a particular object in the NFT image and may be multi-dimensioned. For example, if the NFT depicts a hat in the image, the hat may correspond to an “object’ feature type. Each object feature type may be associated with a color attribute, a style attribute, and/or the like. As such a blue cowboy hat object depicted in the NFT image may have a corresponding contribution feature which describes the contribution feature type and may further describe a “blue” color attribute and “cowboy” style attribute. In some embodiments, the contribution feature is formatted as a variable dimension list, dictionary, vector, array, matrix, and/or the like. The contribution feature may describe the feature type and the one or more attributes. By way of continuing example, the blue cowboy hat object within the NFT may have a corresponding contribution feature in the format <object, blue, cowboy> and the NFT author may have a corresponding contribution feature in the format <author, Jane Doe>.

In some embodiments, the NFT valuation engine 208 may utilize a valuation machine learning framework 300 to generate the plurality of contribution features of the NFT. For example, the valuation machine learning framework 300 may accept the NFT as input via communications hardware 206. The NFT and its associated data may be retrieved from the blockchain network 112. The valuation machine learning framework may include an extraction machine learning model, one or more contribution feature determination machine learning models, one or more per-feature prediction machine learning models, and/or a predictive valuation machine learning model, as depicted in FIG. 3. The valuation machine learning framework may use the one or more included models to process the NFT, generate a plurality of per-feature prediction contribution sores, and/or generate a predictive valuation score for the NFT.

In particular, the NFT valuation engine 208 may use the valuation machine learning framework 300 to extract, process, and/or analyze attributes of the NFT such as the NFT smart contract, the NFT metadata, any multimedia information linked to or associated with the NFT, blockchain data related to transactions of the NFT or related NFTs found on blockchain network 112, or any other related data. The attributes of the NFT may be categorized by one or more models of the valuation machine learning framework 300 into feature types, such as transaction data, creator data, image data, sound data, video data, or the like. The valuation machine learning framework 300 may analyze the various feature data pertaining to the NFT and produce as output the plurality of contribution features. The generated plurality of contribution features may be stored in memory 204 or other storage for later use.

By way of example, the valuation machine learning framework 300 may receive as input an NFT that includes image data, and the image data may depict several buildings with plants and clouds nearby. The valuation machine learning framework 300 may process the NFT to generate the plurality of contribution features, which may include the NFT artist, the NFT collection, the date the NFT was minted, or the like. The plurality of contribution features may further include contribution features related to the image data and objects depicted in the image, such as the buildings (e.g., with attributes including the number of buildings, and for each building, the color, number of windows, height, etc.), plants (e.g., with attribute including the number of plants and for each plant, the color, plant type, etc.), the clouds (e.g., with attributes including the number of clouds, the height of the clouds in the sky, the color, etc.), and/or the like.

In some embodiments, one or more machine learning models of the valuation machine learning framework 300 is trained using a historical NFT transaction data training set. The historical NFT transaction data training set may comprise historical NFT transaction data pertaining to transactions involving the NFT and one or more other NFTs of the same collection. The historical NFT transaction data may include the NFT relevant data (e.g., attributes of the NFT such as the NFT smart contract, the NFT metadata, any multimedia information linked to or associated with the NFT, blockchain data related to transactions of the NFT or related NFTs found on the corresponding blockchain network, or any other related data) as well as the transaction sale data (e.g., number of bids, days on market, transaction price, etc.). The historical NFT transaction data may be partitioned into one or more of the categories of training data which may be used to initially train the one or more machine learning models and fit model parameters, validation data which may be used to tune the one or more machine learning model hyperparameters, and/or testing data, which may be used to evaluate the particular machine learning model. The historical NFT transaction data training set may be retrieved from memory 204 or other storage, or may be retrieved via communications hardware 206 from blockchain nodes of the blockchain network 112, or other remote servers that aggregate such transaction history information. The processor 202 may interpret and structure the historical NFT transaction data to prepare the data as input for a machine learning model by formatting, normalizing, cleaning, infilling, or performing other operations to prepare valid machine learning training data.

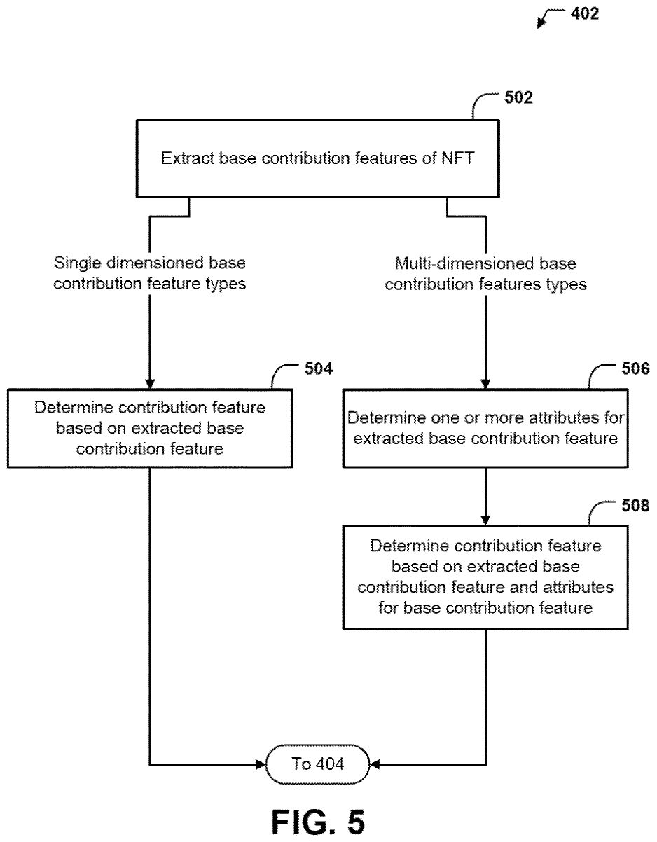

In some embodiments, operation 402 may be performed in accordance with the operations described in FIG. 5. Turning to FIG. 5, detailed operations are shown for generating the plurality of contribution features of the NFT.

As shown by operation 502, the apparatus 200 may include means, such as memory 204, NFT valuation engine 208, or the like, for extracting a plurality of base contribution features of the NFT. The NFT valuation engine 208 may utilize an extraction machine learning model 302 of the valuation machine learning framework 300. The extraction machine learning model may be configured to process an NFT input to generate one or more base contribution features. In some embodiments, the extraction machine learning model may be a trained CNN and/or may use one or more NLP techniques to process the NFT. In some embodiments, the base contribution feature may describe corresponding feature attributes (e.g., unprocessed) of an NFT and may also describe the feature type. In some embodiments, the base contribution feature may be indicative of a feature attribute location (e.g., the pixels corresponding to a feature attribute) within the NFT image, a text sequence, and/or the like.

The base contribution features of the NFT may be basic forms of contribution features that require an additional layer of processing. The extraction machine learning model 302 may extract the base contribution features through a combination of techniques, for example CNN may be used to process image input data, while other techniques such as natural language processing may be applied to text data written in natural language.

The extraction machine learning model 302 may thus select various machine learning models to process the NFT input and extract the plurality of base contribution features, and may produce the base contribution features in any number of output formats. For example, the base contribution features may be generated in a raw byte stream that is passed to another machine learning model via an application programming interface (API), or the base contribution features may be recorded in a persistent data format and stored in non-volatile memory 204 or other non-volatile storage, for example as structured ASCII data. The extraction machine learning model 302 may further make a determination, for each base contribution feature, whether each base contribution feature type is singled dimensioned or multi-dimensional.

In some embodiments, a contribution feature determination machine learning model of the one or more contribution feature determination machine learning model 304A-304N may be used to process one or more base contribution features to generate a contribution feature. In some embodiments, a contribution feature determination machine learning model is a machine learning model which is trained to process base contribution features of a particular feature type. Each contribution feature determination machine learning model may be a trained CNN and/or may use one or more NLP techniques to process the one or more base contribution features. The contribution feature determination machine learning model may determine one or more attributes for a base contribution feature (e.g., a color attribute, style attribute, etc.). The number of attributes determined for a base contribution feature may be dependent upon the feature type associated with the base contribution feature. Attributes may be a primitive data type such as a string, integer, floating point number, or the like. The contribution feature determination machine learning model may determine the contribution feature based on the base contribution feature and the one or more attributes for the base contribution feature.

In an instance where the extracted base contribution feature of the NFT is a singled dimensioned feature type, control may flow to operation 504 as shown by FIG. 5. As shown by operation 504, the apparatus 200 may include means, such as NFT valuation engine 208, or the like, for determining a contribution feature of the plurality of contribution features based on the extracted base contribution feature. The NFT valuation engine 208 may use one or more contribution feature determination machine learning models to determine a contribution feature based on the base contribution feature. The particular contribution feature determination machine learning model which is selected to process the base contribution feature may be determined based on the feature type of the base contribution feature and the feature type the contribution feature determination model is configured to process. To determine the contribution feature from the extracted base contribution feature, the contribution feature determination machine learning model may apply various data preparation routines to format, clean, normalize, infill, or otherwise prepare the extracted base contribution feature to be used as input for any subsequent layer of the valuation machine learning framework 300. The contribution feature determination machine learning model may copy the single dimensional base contribution feature as determined by the extraction machine learning model 302 to create a contribution feature without a variable dimensional data structure, such as a string, integer, floating point number, or other primitive data type.

In the instance the base contribution is associated with a multi-dimensioned feature type, the process may proceed to operation 506. As shown by operation 506, the apparatus 200 may include means, such as NFT valuation engine 208, or the like, for determining one or more attributes for the extracted base contribution feature. As shown by operation 506, the apparatus 200 may include means, such as NFT valuation engine 208, or the like, for determining a contribution feature of the plurality of contribution features based on the extracted base contribution feature. The NFT valuation engine 208 may use one or more contribution feature determination machine learning models to determine a contribution feature based on the base contribution feature. The particular contribution feature determination machine learning model which is selected to process the base contribution feature may be determined based on the feature type of the base contribution feature and the feature type the contribution feature determination model is configured to process.

In the instance the base contribution is associated with a multi-dimensioned feature type, the contribution feature determination machine learning model may determine one or more attributes for the extracted base combination feature. The contribution feature determination machine learning model may determine one or more attributes for a base contribution feature (e.g., a color attribute, style attribute, etc.). The number of attributes determined for a base contribution feature may be dependent upon the feature type associated with the base contribution feature. Attributes may be a primitive data type such as a string, integer, floating point number, or the like. The contribution feature determination machine learning model may the determine the contribution feature based on the base contribution feature and the one or more attributes for the base contribution feature.

As shown by operation 508, the apparatus 200 may include means, such as NFT valuation engine 208, or the like, for determining a contribution feature of the plurality of contribution features based on the extracted base contribution feature and one or more attributes for the base contribution feature. In particular, the NFT valuation engine 208 may use the corresponding contribution feature determination machine learning model to determine the contribution feature based on the extracted base contribution feature and attributes. The contribution feature determination machine learning model 304A may aggregate the attributes from the extracted base contribution feature into a data structure. The data structure may organize the attributes of the extracted base contribution feature for a particular purpose. For example, data may be collected into arrays, lists, vectors, maps, or the like to pass to an API that uses the contribution feature for subsequent processing within the valuation machine learning framework 300. In some embodiments, the contribution feature determination machine learning model may prepare the contribution features in a simple flat structure to be passed as input features directly to a subsequent machine learning model.

In some embodiments, each contribution feature determination machine learning model 304A-304N is configured to generate one or more attributes for a particular base contribution feature type. For example, a particular contribution feature determination machine learning model 304A may be trained to generate attributes for historical price data of the NFT. The contribution feature determination machine learning model 304A may produce several attributes, such as the historic high price, three-month high price, or other attributes that the contribution feature determination machine learning model 304A determines to be useful for valuing the NFT.

By way of continued example, an example NFT may include image data that depicts several buildings with plants and clouds nearby. The contribution feature determination machine learning model 304B may be configured to process base contribution features associated with an “object” feature type. As such, the contribution feature determination machine learning model 304B may determine attributes for each of the buildings, each plant of the collection of plants, and each cloud of the collection of clouds, each of which are associated with a base contribution feature. For example, the contribution feature determination machine learning model 304B may identify one or more attributes for each building, such as the number of windows on the building, the color of the building, the height of the building, the architectural style of the building, or the like. The resulting contribution feature may thus include the feature type (e.g., object) and the one or more attributes.

Returning to FIG. 4, as shown by operation 404, the apparatus 200 includes means, such as processor 202, memory 204, communications hardware 206, NFT valuation engine 208, or the like, for determining a plurality of per-feature prediction contribution scores. Each per-feature prediction contribution score corresponds to a contribution feature, and the NFT valuation engine 208 may utilize the valuation machine learning framework 300 to determine the contribution scores. The contribution scores may provide a measure of the relative value of each contribution feature in determining the overall value of the NFT. For example, one NFT may have associated image data with a particular art attribute that contributes a large value to the overall NFT value, while a second NFT may have a small value associated with the same art attribute of its image data. The NFT valuation engine 208 may make the determination of the per-feature prediction contribution scores as output by considering the contribution features and any associated attributes of the NFT. As such each contribution feature as determined by the one or more contribution feature determination machine learning models 304A-304N may be assigned a per-feature prediction contribution score. In some embodiments, the NFT valuation engine 208 may use one or more per-feature prediction machine learning models 306A-306N to determine the plurality of per-feature prediction contribution scores.

By way of continued example, an example NFT with image data depicting several buildings, plants, and clouds may have contribution features including each building, the collection of plants, and the collection of clouds, in addition to other contribution features not directly derived from the image data. The NFT valuation engine 208 may determine the plurality of per-feature prediction scores, for example assigning values, each normalized to 1. The per-feature prediction contribution scores may be 0.5 for the NFT artist contribution feature, 0.4 for the first building in the image data, and 0.2 for a plant of the collection of plants in the image data. In some embodiments the per-feature prediction contribution scores may be in units of currency, and may represent the contribution to the total valuation of the NFT. In some embodiments, the per-feature prediction contribution scores may not be normalized, and may be in arbitrary units interpreted by the valuation machine learning framework 300.

As described above, in some embodiments, the NFT valuation engine 208 may determine the per-feature prediction contribution score for the contribution feature, using one of the per-feature prediction machine learning model 306A, which may be configured to generate the per-feature prediction contribution score for a particular contribution feature type. A per-feature prediction machine learning model may be configured to process one or more contribution features to generate a per-feature prediction contribution score. In some embodiments, the contribution feature determination machine learning model is a machine learning model which is trained to process contribution features of a particular feature type. In some embodiments, the per-feature prediction machine learning model may be trained using an NFT training data set which includes previous NFT transactions and corresponding NFT contribution features. The per-feature prediction machine learning model may be configured to generate a per-feature prediction contribution score for the contribution feature based on the one or more attributes of the contribution feature. Each per-feature prediction contribution may be indicative of an estimated value of the contribution feature.

The per-feature prediction machine learning model may take a contribution feature as input, where the contribution feature corresponds to a feature type the per-feature prediction machine learning mode is associated with (e.g., trained for). The per-feature prediction machine learning model may output the per-feature prediction contribution score as numerical values for each contribution feature of the NFT. In doing so, the per-feature prediction machine learning model may generate a numerical value for each contribution feature, regardless of dimensionality, thereby harmonizing the dimensionality for all contribution features into a single dimensioned per-feature prediction contribution score.

As shown by operation 406, the apparatus 200 includes means, such as memory 204, NFT valuation engine 208, or the like, for determining a predictive valuation score for the NFT based on each per-feature prediction contribution score. The NFT valuation engine 208 may utilize the valuation machine learning framework 300 to receive the per-feature prediction contribution score as input. Each per-feature prediction contribution score may be read from memory 204 or other storage and passed through the valuation machine learning framework. The NFT valuation engine 208 may perform processing of the per-feature prediction contribution scores in order to interpret them as features for a machine learning model. In some embodiments, the NFT valuation engine 208 may use a predictive valuation machine learning model 308 to determine the predictive valuation score.

By way of continued example, an example NFT with contribution features including several buildings, plants, and trees depicted in image data may have various per-feature prediction contribution scores associated to each contribution feature. The NFT valuation engine 208 may utilize the per-feature prediction contribution scores with data about each contribution feature to determine a predictive valuation for the NFT. For example, the NFT valuation engine 208 may process the per-feature prediction contribution scores and assign weights to each, based on the relative importance of each contribution feature to the overall value of the NFT. The NFT valuation engine 208 may, for example, assign a large weight to the attributes of the building in the image data, and a relatively small weight to the collection of plants in the image data, arriving at a total valuation that depends more strongly on the properties of the building in the image data.

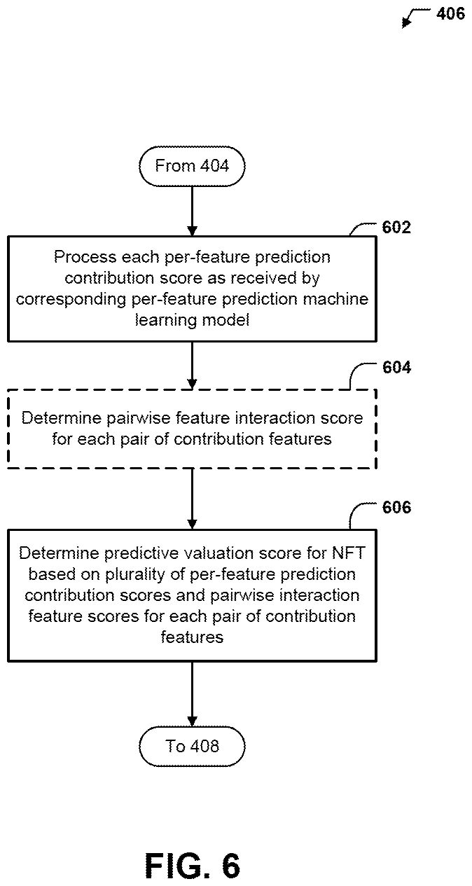

In some embodiments, operation 406 may be performed in accordance with the operations described in FIG. 6. Turning to FIG. 6, detailed operations are shown for determining the predictive valuation score for the NFT based on per-feature prediction contribution scores.

As shown by operation 602, the apparatus 200 may include means, such as NFT valuation engine 208, or the like, for determining the predictive valuation score for the NFT based on the plurality of per-feature prediction contribution scores. The NFT valuation engine 208 may utilize the predictive valuation machine learning model 308, which may be configured to process each per-feature prediction contribution score as received by a corresponding per-feature prediction machine learning model 306A. The predictive valuation machine learning model may be configured to process one or more per-feature prediction contribution scores to generate a predictive valuation score. In some embodiments, the predictive valuation machine learning model is a machine learning model is configured to process per-feature prediction contribution scores from each per-feature prediction machine learning model. In some embodiments, the predictive valuation machine learning model may be trained using an NFT training data set which includes previous NFT transactions and corresponding NFT contribution features. The predictive valuation machine learning model may be configured to generate the predictive valuation score based on the one or more each per-feature prediction contribution scores. In some embodiments, each per-feature prediction contribution may be weighted using a parameter obtained during predictive valuation machine learning model training. In some embodiments, the predictive valuation score is determined based on one or more pairwise feature interaction scores obtained for each pair of contribution features.

The predictive valuation machine learning model 308 may process each per-feature prediction contribution score by appropriately formatting, normalizing, cleaning, infilling, or otherwise preparing the data for input as features to the machine learning model. The processing may involve forming a decision about which contribution feature scores to use, for example if certain contribution feature scores are based on limited data such as the case of limited transaction history data for a relatively new NFT or relatively unknown NFT creator.

Optionally, in some embodiments and as shown by operation 604, the apparatus 200 may include means, such as NFT valuation engine 208, or the like, for determining a pairwise feature interaction score for each pair of contribution features. The NFT valuation engine 208 may utilize the predictive valuation machine learning model 308 of the valuation machine learning framework 300 to analyze each pair of contribution features in turn. While analyzing a candidate pair of features, the predictive valuation machine learning model 308 may be trained on historical data for similar NFTs that use a similar or the same combination of contribution features. The predictive valuation machine learning model 308 may assign a contribution score to each pair of contribution features, which are retained together with the per-feature contribution scores of each contribution feature to be used as inputs to compute the predictive valuation score for the NFT. A pairwise feature interaction score may be indicative of the overall effect of the two contribution features and/or their attributes have on each other. For example, a blue building contribution feature depicted in the same image as a red flower contribution feature may have a highly positive impact (e.g., may be highly valued on the market) whereas a blue building contribution feature depicted in the same image as a blue flower contribution feature may have a slightly negative impact (e.g., may not be valued on the market).

As shown by operation 606, the apparatus 200 may include means, such as memory 204, NFT valuation engine 208, or the like, for determining the predictive valuation score for the NFT based on the plurality of per-feature prediction contribution scores and the pairwise interaction feature scores for each pair of contribution features. The NFT valuation engine 208 may utilize the predictive valuation machine learning model 308 of the valuation machine learning framework 300 to collect each of the per-feature prediction contribution scores and pairwise interaction feature scores from memory 204 or other storage, and may apply each score as an input to the machine learning model. The machine learning model of the predictive valuation machine learning model 308 may in effect weight each input feature differently, applying a large weight to the value of features that buyers and sellers of NFTs may value highly, and lower weights to other features. The predictive valuation machine learning model 308 may produce as output a predictive valuation score which may be associated with a monetary valuation of the NFT. In some embodiments the predictive valuation score may be normalized or converted to units of an appropriate currency.

In some embodiments, the predictive valuation machine learning model 308 also determine a confidence score for the predictive valuation score. The confidence score may be determined based on the availability of similar historical training data. For example, if the majority of the contribution features of the NFT are similar to historical NFT training data, the confidence score may be high whereas a lack of similarity between contribution features of the NFT to historical NFT training data may result in a low confidence score.

Returning to FIG. 4, as shown by operation 408, the apparatus 200 may include means, such as NFT valuation engine 208, or the like, for determining a predicted risk category for the NFT based at least in part on the predictive valuation score. The NFT valuation engine 208 may utilize as input various input data from the valuation machine learning framework 300, such as the number of contribution features, the uncertainty related to various contribution features, the sample size of available training data for the valuation machine learning framework 300, or the like. The NFT valuation engine 208 may utilize these input features in combination with the predictive valuation score and/or aspects of the calculation of the predictive valuation score from the predictive valuation machine learning model 308. The NFT valuation engine 208 may assign risk based on a confidence score associated with the predictive valuation score. For example, a predictive valuation score with a large uncertainty score may be evaluated as high risk, whereas a predictive valuation score with small uncertainty or a narrow confidence score may be evaluated as lower risk. The predicted risk category may be assigned based on an underlying numerical risk estimate produced by the NFT valuation engine 208 when evaluating risk.

As shown by operation 410, the apparatus 200 includes means, such as processor 202, memory 204, communications hardware 206, or the like, for providing a predictive valuation report for the NFT based on at least one of the plurality of per-feature prediction contribution scores or the predictive valuation score. The predictive valuation report may describe the predictive valuation for an NFT and/or an expected value for the sale or purchase price of the NFT. The predictive valuation report may further include a confidence interval, a classification of the NFT valuation into one or more categories, and/or detailed valuation information related to the contribution features of the NFT.

The processor 202 may evaluate the predictive valuation score and each of the per-feature prediction contribution scores to determine a predictive valuation report. For example, in an instance where missing data or an incomplete model causes an invalid predictive valuation score, one or more of the prediction contribution scores may be used as a fallback to report in the predictive valuation report. In another example, the predictive valuation report for the NFT may comprise the predictive valuation score, and may also represent how each of the per-feature prediction contribution scores contribute to the overall predictive valuation score of the NFT, in order to provide insight to contribution features that are highly valued for the NFT.

The communications hardware 206 may prepare the predictive valuation report and produce a formatted output, for example as a webpage comprising visual representations of the per-feature prediction contributions cores and the predictive valuation scores, and may make visual comparisons of the predictive valuation score with recent transactions of the NFT and recent transactions of similar NFTs. The apparatus 200 may display the predictive valuation report to the user via communications hardware 206, or the report may be transmitted via communications network 108 to one of the user devices 110A-110N. The predictive valuation report may be customized to suit a particular style desired by a user. For example, a potential buyer may be interested in reporting contribution features that may be altered to reduce the price of an NFT, while an NFT creator may be interested in reporting the most highly-value contribution features to know what modifications could be made to future NFTs to maximize value.

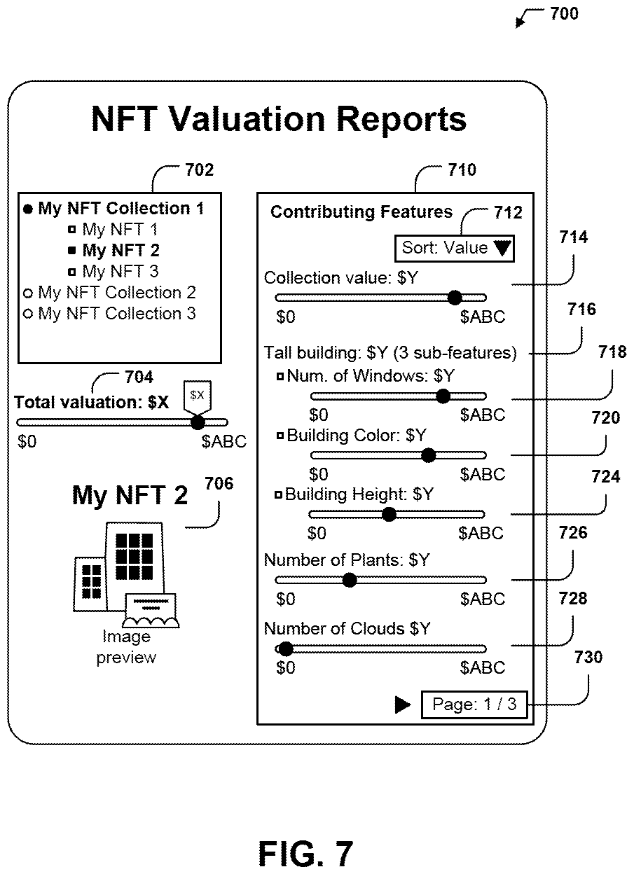

Turning to FIG. 7, an example user interface 700 is shown for presenting the predictive valuation report for the NFT to the user. The example user interface includes a list of NFT valuation reports 702, general information including the total valuation 704 and image preview 706, and detailed information about per-feature contribution scores 710.

The list of NFT valuation reports 702 may group valuation reports by collection, as shown in the example diagram. The collections in the list of NFT valuation reports 702 may be selectable to expand or collapse the collections, and the individual NFT reports may be selected to display the relevant predictive valuation report in the example user interface 700.

The total valuation 704 may give a summary numerical value to the total valuation of the NFT. The user interface element may include a graphical reference that shows the total valuation relative to a scale, for example the minimum and maximum valuation of NFTs in the same collection, the minimum and maximum valuation of NFTs in the user's wallet, or the like. The image preview 706 may display any image data associated with the NFT when image data is available. The area of the image preview 706, may alternatively include a video player user interface, audio player user interface, or the like for previewing digital data associated with the NFT.

The detailed information about per-feature contribution scores 710 may include information about the various contribution features of the NFT. The depicted list of contribution features shows one possible example for an NFT with image data including buildings, plants, and clouds. Other example embodiments or reports of other example NFTs may list different per-feature contribution scores depending on the metadata and/or image data of the example NFT. The sorting method selector 712 may allow sorting of the contribution features by different values, such as value (as shown), alphabetical order, weight, or the like. A first contribution features 714 may be displayed with a numerical value, and a user interface element may further give a graphical representation of the contribution feature value relative to some maximum, such as the total valuation of the NFT. A second contribution feature 716 may be a multi-dimensioned base contribution feature, and the second contribution feature 716 may have several attributes which are each displayed below. A first attribute of the second contribution feature 718 may be displayed, and in the same way a second attribute of the second contribution feature 720 and a third attribute of the second contribution feature 724 may be displayed below. Each attribute may display the attribute's individual contribution to the total valuation together with a graphical representation of the attribute value. A third contribution feature 726 and fourth contribution feature 728 may also be displayed below. Finally, a page selector 730 may be included to allow the user to view additional contribution features by advancing to the next page and/or selecting a page from a listing of pages.

FIGS. 4, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 4-6 may be modified or further amplified. Furthermore, in some embodiments, additional optional operations may be included. Modifications, amplifications, or additions to the operations above may be performed in any order and in any combination.

As described above, example embodiments provide methods and apparatuses that enable improved valuation of NFTs. Example embodiments thus facilitate improved use of blockchain technology (for example, using a historical NFT transaction data training set) for performing transactions involving NFTs, improving confidence of buyers and sellers of NFTs. Furthermore, banks and other entities that rely on valuation of assets may be more confidently able to recognize NFTs as equity, for example, by determining a predicted risk category for NFTs. While general interest in trading NFTs has grown rapidly in recent years, the difficulty of predicting the value of these assets has caused problems for traders and financial institutions in legitimating them as financial assets. At the same time, the growing dataset of past NFT transactions has enabled new avenues of solving these problems, and example embodiments described herein thus represent a technical solution to these real-world problems.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for generating a predictive valuation for a non-fungible token (NFT) associated with an NFT image, the method comprising:
generating, by a NFT valuation engine and using a valuation machine learning framework, a plurality of base contribution features of the NFT, wherein each base contribution feature corresponds to a feature attribute of the NFT image associated with the NFT and each base contribution feature is associated with a feature type;
determining, by the NFT valuation engine and using a contribution feature determination machine learning model of the valuation machine learning framework, a contribution feature based on the plurality of base contribution features;
determining, by the NFT valuation engine and using the valuation machine learning framework, a plurality of per-feature prediction contribution scores, wherein each per-feature prediction contribution score corresponds to a particular contribution feature;
determining, by the NFT valuation engine and using the valuation machine learning framework, a predictive valuation score for the non-fungible token based on each per-feature prediction contribution score; and
providing, by a communications hardware, a predictive valuation report for the non-fungible token based on at least one of the plurality of per-feature prediction contribution scores or the predictive valuation score.

2. (canceled)

3. The method of claim 1, further comprising:
for one or more base contribution features:
determining, by the NFT valuation engine and using the contribution feature determination machine learning model of the valuation machine learning framework, one or more attributes for the base contribution feature; and
determining, by the NFT valuation engine and using the contribution feature determination machine learning model of the valuation machine learning framework, a contribution feature based on the base contribution feature and the one or more attributes for the base contribution feature.

4. The method of claim 3, wherein each contribution feature determination machine learning model is configured to generate the one or more attributes for a particular base contribution feature type.

5. The method of claim 1, further comprising:
for each base contribution feature:
determining, by the NFT valuation engine and using a per-feature prediction machine learning model of the valuation machine learning framework, the per-feature prediction contribution score for each base contribution feature, wherein the per-feature prediction machine learning model is configured to generate the per-feature prediction contribution score for a particular contribution feature type.

6. The method of claim 1, further comprising:
determining, by the NFT valuation engine and using a predictive valuation machine learning model of the valuation machine learning framework, the predictive valuation score for the NFT based on the plurality of per-feature prediction contribution scores, wherein the predictive valuation machine learning model is configured to process each per-feature prediction contribution score as received by a corresponding per-feature prediction machine learning model.

7. The method of claim 6, further comprising:
determining, by the NFT valuation engine and using the predictive valuation machine learning model of the valuation machine learning framework, a pairwise feature interaction score for each pair of base contribution features; and
determining, by the NFT valuation engine and using the predictive valuation machine learning model of the valuation machine learning framework, the predictive valuation score for the non-fungible token based on the plurality of per-feature prediction contribution scores and the pairwise feature interaction score for each pair of the base contribution features.

8. The method of claim 1, wherein each contribution feature may be a data structure of variable dimensionality.

9. The method of claim 1, further comprising:
determining, by the NFT valuation engine, a predicted risk category for the NFT based at least in part on the predictive valuation score.

10. The method of claim 1, wherein:
one or more machine learning models of the valuation machine learning framework is trained using a historical NFT transaction data training set,
the NFT belongs to a collection of NFTs, and
the historical NFT transaction data training set comprises historical transaction data pertaining to transactions involving the NFT and one or more other NFTs belonging to the collection of NFTs.

11. An apparatus for generating a predictive valuation for a non-fungible token (NFT) associated with an NFT image, the apparatus comprising:
an NFT valuation engine configured to:
generate, using a valuation machine learning framework, a plurality of base contribution features of the NFT, wherein each base contribution feature corresponds to a feature attribute of the NFT image associated with the NFT and each base contribution feature is associated with a feature type,
determine, using a contribution feature determination machine learning model of the valuation machine learning framework, a contribution feature based on the plurality of base contribution features,
determine, using the valuation machine learning framework, a plurality of per-feature prediction contribution scores, wherein each per-feature prediction contribution score corresponds to a particular contribution feature, and
determine, using the valuation machine learning framework, a predictive valuation score for the non-fungible token based on each per-feature prediction contribution score; and
communications hardware configured to:
provide a predictive valuation report for the non-fungible token based on at least one of the plurality of per-feature prediction contribution scores or the predictive valuation score.

12. (canceled)

13. The apparatus of claim 11, wherein the NFT valuation engine is further configured to:
for one or more base contribution features:
determine, using the contribution feature determination machine learning model of the valuation machine learning framework, one or more attributes for the base contribution feature, and
determine, using the contribution feature determination machine learning model of the valuation machine learning framework, a contribution feature based on the base contribution feature and the one or more attributes for the base contribution feature.

14. The apparatus of claim 13, wherein each contribution feature determination machine learning model is configured to generate the one or more attributes for a particular base contribution feature type.

15. The apparatus of claim 11, wherein the NFT valuation engine is further configured to:
for each base contribution feature:
determine, using a per-feature prediction machine learning model of the valuation machine learning framework, the per-feature prediction contribution score for each base contribution feature, wherein the per-feature prediction machine learning model is configured to generate the per-feature prediction contribution score for a particular contribution feature type.

16. The apparatus of claim 11, wherein the NFT valuation engine is further configured to:
determine, using a predictive valuation machine learning model of the valuation machine learning framework, the predictive valuation score for the NFT based on the plurality of per-feature prediction contribution scores, wherein the predictive valuation machine learning model is configured to process each per-feature prediction contribution score as received by a corresponding per-feature prediction machine learning model.

17. The apparatus of claim 16, wherein the NFT valuation engine is further configured to:
determine, using the predictive valuation machine learning model of the valuation machine learning framework, a pairwise feature interaction score for each pair of contribution features; and
determine, using the predictive valuation machine learning model of the valuation machine learning framework, the predictive valuation score for the non-fungible token based on the plurality of per-feature prediction contribution scores and the pairwise feature interaction score for each pair of the base contribution features.

18. The apparatus of claim 11, wherein each contribution feature may be a data structure of variable dimensionality.

19. The apparatus of claim 11, wherein the NFT valuation engine is further configured to:
determine a predicted risk category for the NFT based at least in part on the predictive valuation score.

20. A computer program product for generating a predictive valuation for a non-fungible token (NFT) associated with an NFT image, the computer program product comprising at least one non-transitory computer-readable storage medium storing software instructions that, when executed, cause an apparatus to:
generate, using a valuation machine learning framework, a plurality of base contribution features of the NFT, wherein each base contribution feature corresponds to a feature attribute of the NFT image associated with the NFT and each base contribution feature is associated with a feature type;
determine, using a contribution feature determination machine learning model of the valuation machine learning framework, a contribution feature based on the plurality of base contribution features;
determine, using the valuation machine learning framework, a plurality of per-feature prediction contribution scores, wherein each per-feature prediction contribution score corresponds to a particular contribution feature;
determine, using the valuation machine learning framework, a predictive valuation score for the non-fungible token based on each per-feature prediction contribution score; and
provide a predictive valuation report for the non-fungible token based on at least one of the plurality of per-feature prediction contribution scores or the predictive valuation score.

21. The computer program product of claim 20, wherein the software instructions, when executed, cause the apparatus to:
for one or more base contribution features:
determine, using the contribution feature determination machine learning model of the valuation machine learning framework, one or more attributes for the base contribution feature, and
determine, using the contribution feature determination machine learning model of the valuation machine learning framework, a contribution feature based on the base contribution feature and the one or more attributes for the base contribution feature.

22. The computer program product of claim 21, wherein each contribution feature determination machine learning model is configured to generate the one or more attributes for a particular base contribution feature type.
